(19) United States
(12) Patent Application Publication
(10) Pub. No.: US 2003/0069754 A1
(43) Pub. Date: Apr. 10, 2003

(54) Methods and system for processing healthcare referrals

(76) Inventors: Wallace W. Weeks JR., Melbourne, FL (US); Jeffry Lee Harris, Indialantic, FL (US)

Correspondence Address: JEFFREY S. WHITTLE, BRACEWELL & PATTERSON, P.O. BOX 61389, HOUSTON, TX, 77208-1389, US

(21) Appl. No.: 10/238,017

(22) Filed: Sep. 9, 2002

Related U.S. Application Data
(60) Provisional application No. 60/318,472, filed on Sep. 10, 2001.

(51) Int. Cl. G06F 17/60

(52) U.S. Cl. 705/2

(57) ABSTRACT

A healthcare referral system and methods for processing healthcare referrals are provided. The system preferably includes a server computer, an originator computer having originator software stored therein, a recipient computer having recipient software stored therein, a database of originators, a database of recipients, a database of referrals, and a database of confirmations. The healthcare referral system advantageously shortens the time to make a referral and reduces referral data error by populating forms with originator and patient data required by the recipient and transmitting the referral to the recipient via the server computer. The healthcare referral system also provides detailed records of the referral by storing referred patient data on the recipient's computer and transmitting a confirmation of referral and referral time to the originator.

### RELATED APPLICATIONS

This is a non-provisional patent application, which claims the priority of provisional patent application U.S. Serial No. 60/318,472, filed Sep. 10, 2001, and titled Healthcare Referral System, Software, and Associated Methods, which is incorporated herein by reference in its entirety.

### BACKGROUND OF THE INVENTION

1. Technical Field

The present invention relates to the healthcare industry in general and, in particular, to methods and systems for healthcare referrals.

2. Description of the Related Art

The referral process in the healthcare industry is typically executed as follows. When an originator, such as a physician, desires to refer a patient to a recipient, such as a home medical equipment provider, the referral process begins with the originator placing a telephone call to the recipient's office. After ascertaining the intent of the originator's call, the operator of the recipient then routes the call to the intake coordinator of the recipient. Once connected to the intake coordinator, the originator provides answers to a battery of patient related questions, which may include contact data, diagnosis, and needs to the intake coordinator such that the intake coordinator can complete a form for the recipient's system based on the answer given by the originator.

Thus, the typical referral process is often very tedious and time-consuming. The typical referral process is often quite slow because it can only proceed as fast as the intake coordinator can handle the referral. In addition, the time for making a referral may cost the originator money because the support staff of the originator is prevented from performing other work-related tasks during the time taken for completing a referral. Furthermore, the verbal transmission of patient information is inherently error prone because errors occur during reading (e.g., incorrect reading of the patient information by the originator) or during writing (e.g., incorrect recording of patient information by the recipient). Such communication errors may have serious consequences, especially when the error involves vital data about the patient's condition. Thus, the typical referral process is undesirable because it is limited by many factors such as staff availability, telephone circuit availability, common business hours between the originator and the recipient, and verbal communication skills of both the originator and the recipient.

At times, a recipient may not be even able to find a patient's information, usually caused by improperly entered data due to human error. At such point, the originator, the recipient or even the patient must retrace the specific referral in an attempt to find out what happened to the referral data. Such a process often leads to patient data being redelivered and, in turn, causes a problem of duplicate patient records being generated by the recipient. Consequently, it is desirable to provide enhanced methods and systems for processing referrals such as within the healthcare industry.

### SUMMARY OF THE INVENTION

The present invention advantageously provides a method and system, which enhances processing of referrals within an industry, such as the healthcare industry, more efficiently. The present invention also advantageously provides a method and system for processing referrals, which substantially reduces the risk of errors in the referral process. The present invention additionally provides a method and system for making referrals through a global communication network that substantially reduces the risk that confidential healthcare data will be inadvertently disclosed. The present invention further advantageously provides a method and systems for performing or processing referrals which reduces risk of duplication of communication, enhances confidence in referral origination and receipt, and more accurately tracks referral data.

A healthcare referral system of the present invention preferably includes a server computer in communication with an originator computer and a recipient computer. The server computer preferably includes a secure server connector, an originator confirmer, a referral data mover, a recipient confirmer, and a referral transmission confirmer. The secure server connector allows the originator computer to communicate with the recipient computer while keeping the nature of the communications private. The originator confirmer confirms the identity of the originator computer. The referral data mover receives referrals from the originator computer and, in turn, transmits the referrals to the recipient computer. The recipient confirmer confirms the identity of a recipient. The referral transmission confirmer records data related to a referral and transmits that data to the originator computer. The server computer also has access to a database of originators, a database of referrals, a database of recipients, and a database of confirmations. Such databases are preferably located within the server computer but may also be in communication with the server computer via a local-area network or in communication with the server computer via a global communications network such as the Internet.

The originator computer preferably has originator software stored thereon. The originator software preferably includes an originator graphical user interface (GUI) for simplifying the data-entry process, a referral form generator for generating recipient specific forms on which patient information is entered, a secure originator connector for establishing private communications with the server computer, and a database of patient data for populating patient forms. The recipient computer preferably has recipient software stored thereon. The recipient software preferably includes a recipient GUI for simplifying the data-entry process, a referral checker for accessing the server computer at regular intervals to determine whether or not a new referral is available, a secure recipient connector for establishing private communication with the server computer, and a database of referred patient data for storing referrals transmitted to the recipient computer.

In response to the receipt of a referral retrieval request from the recipient computer, the server computer transmits a completed referral form to the recipient computer. The referral retrieval request preferably includes a recipient identification code that matches with one of the recipient identification codes stored in the server computer. Then, the server computer transmits a first confirmation message to the originator computer if the recipient identification code in the completed referral form matches with one of the recipient identification codes stored in the server computer. After a successful transmission of the completed referral form from the server computer to the recipient computer, the recipient computer transmits a second confirmation message to the server computer. Next, the server computer immediately transmits the second confirmation message to the originator computer to indicate the referral is successful.

The present invention also includes a method for processing healthcare referrals within healthcare industry. The method includes transmitting a completed referral form having a unique recipient identification code associated therewith from an originator computer to a server computer having the unique recipient identification code as one of a plurality of recipient identification codes stored therein, transmitting the completed referral form from the server computer to a recipient computer responsive to the receipt of a referral retrieval request from the recipient computer by the server computer and the referral retrieval request including a recipient identification code that matches with the unique recipient identification code stored in the server computer, transmitting a confirmation message from the recipient computer to the server computer responsive to a successful transmission of the completed referral form from the server computer to the recipient computer, and transmitting the confirmation message from the server computer to the originator computer.

The present invention still also provides a computer program product residing on a computer usable medium for processing referrals such as in within a healthcare industry. The computer program product includes program code means for transmitting a completed referral form having a unique recipient identification code associated therewith from an originator computer to a server computer having the unique recipient identification code as one of a plurality of recipient identification codes stored therein, program code means for transmitting the completed referral form from the server computer to a recipient computer responsive to the receipt of a referral retrieval request from the recipient computer by the server computer and the referral retrieval request including a recipient identification code that matches the unique recipient identification code stored in the server computer, program code means for transmitting a second confirmation message from the recipient computer to the server computer responsive to a successful transmission of the completed referral form from the server computer to the recipient computer, and program code means for transmitting the second confirmation message from the server computer to the originator computer.

With the healthcare referral system and methods of the present invention, a referral originator does not have to look up the telephone number of a recipient, does not have to wade through an automated telephone attendant, does not have to wait on an intake coordinator who most likely transcribes slower than the originator talks. Similarly, a referral recipient can also advantageously reduce telephone time and staff costs when taking referrals. With the referral system and methods of the present invention, referral information can be stored on a hard drive of the originator computer and can be automatically called up with a subsequent referral for a same patient such that staff time used in making a referral can be reduced.

### BRIEF DESCRIPTION OF THE DRAWINGS

Some of the features and advantages of the present invention having been stated, others will become apparent as the description proceeds when taken in conjunction with the accompanying drawings, in which:

FIG. 1 is a schematic diagram of an originator and a recipient of a healthcare referral system according to an embodiment of the present invention;

FIG. 2 is a block diagram of a healthcare referral system according to an embodiment of the present invention;

FIG. 3 is a block diagram of the software related components within a healthcare referral system according to an embodiment of the present invention;

FIG. 4 is a front plan view of an originator registration form on a display of an originator computer of a healthcare referral system according to an embodiment of the present invention; and

FIG. 5 is a flow diagram illustrating a method for processing healthcare referrals within a healthcare referral system according to an embodiment of the present invention.

### DETAILED DESCRIPTION

The present invention will now be described more fully with reference to the accompanying drawings. The present invention, however, may be embodied in many different forms and should not be construed as limited to the illustrated embodiments set forth herein. Rather, such embodiments are provided so that the present disclosure will be thorough and complete, and will fully convey the scope of the present invention to those skilled in the art. Like numbers refer to like elements throughout, and prime notation, if used, indicates similar elements in alternative embodiments.

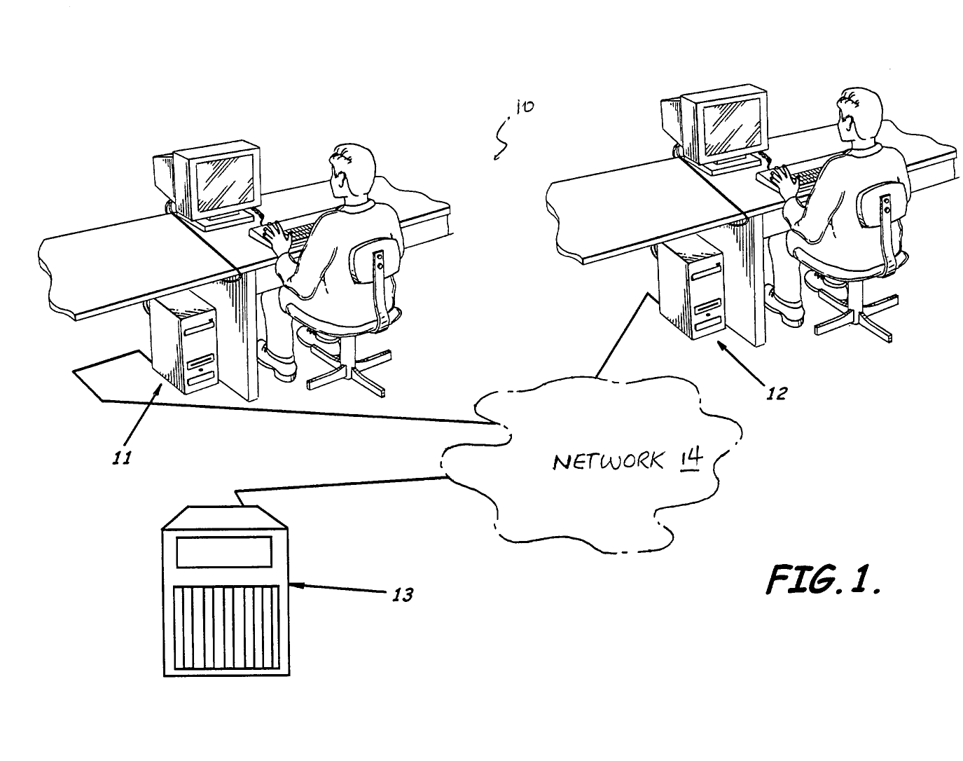

FIG. 1 illustrates an originator and a recipient using a healthcare referral system according to an embodiment of the present invention. As shown, a healthcare referral system 10 of the present invention preferably includes an originator computer 11, a recipient computer 12, and a server computer 13. The originator computer 11, the recipient computer 12, and the server computer 13 can be a personal computer, a mid-range computer or a mainframe computer. Each of the computers can include a display or monitor, such as a CRT, LCD, or other screen, as shown, a hard drive, and a user interface such as a keyboard, mouse, data collection, or other device In addition, the originator computer 11 and the recipient computer 12 can be a stand-alone system or part of a network such as a local-area network (LAN) or a wide-area network (WAN). The originator computer 11, the recipient computer 12, and server computer 13 can be interconnected among each other via a global communication network 14 such as the Internet. An originator can access the server computer 13 through the global communication network 14 via the originator computer 11. Similarly, a recipient can access the server computer 13 through the global communication network 14 via the recipient computer 12.

I. Hardware Components

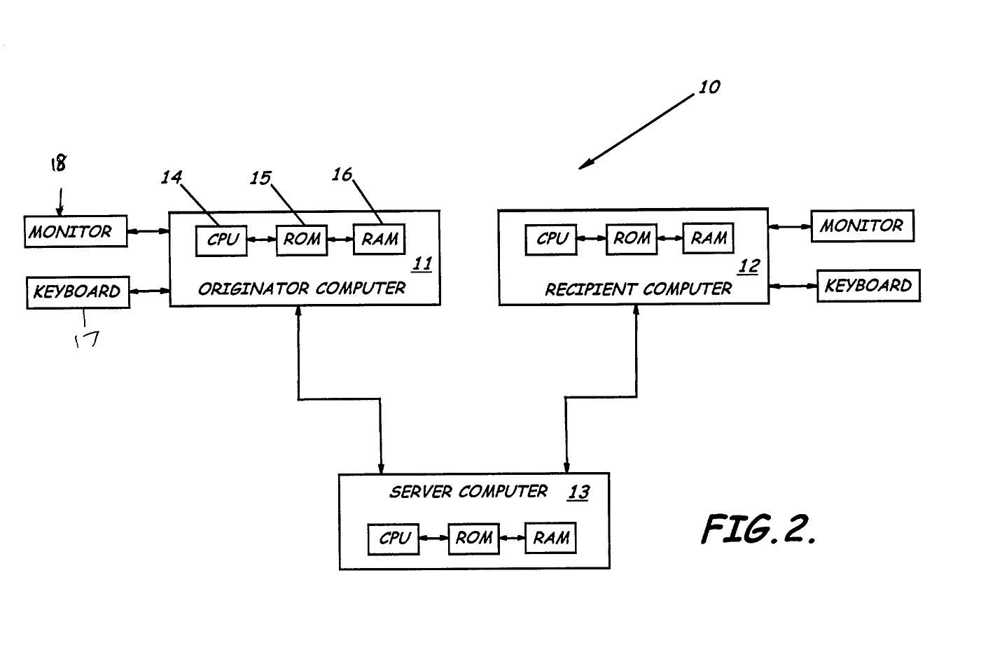

FIG. 2 is a block diagram of the healthcare referral system 10 according to an embodiment of the present invention. As shown, each of the originator computer 11, the recipient computer 12, and the server computer 13 preferably includes a central processing unit (CPU), a read-only memory (ROM), and a random access memory (RAM), as they are understood by those skilled in the art. For example, as depicted in FIG. 2, the originator computer 11 includes a CPU 14, a ROM 15, and a RAM 16. Information can be input to the originator computer 11 via a keyboard 17, and information can be output from the originator computer 11 via a monitor 18. Other commonly known input devices, such as mice, touch screens, etc., and output devices, such as printers, facsimile machines, etc., can be used as well as understood by those skilled in the art. As mentioned previously, the originator computer 11 and the recipient computer 12 are in communication with the server computer 13 via a global communications network 14 such as the Internet.

II. Software Components

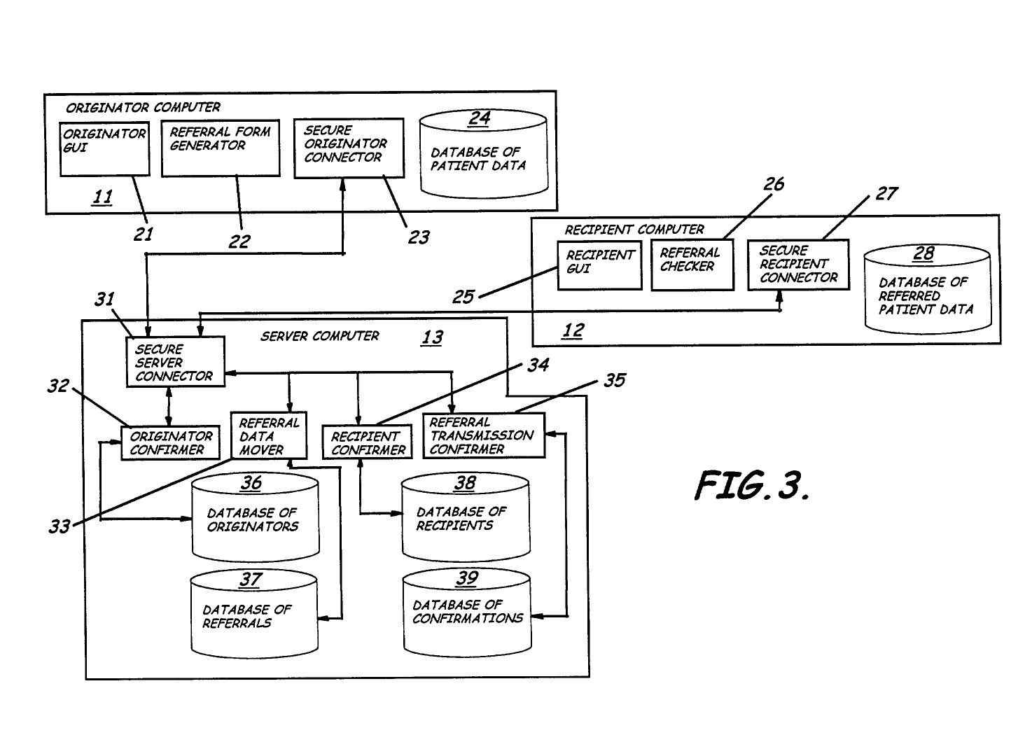

FIG. 3 is block diagram related to various software modules that can be used within the healthcare referral system 10, in accordance with an embodiment of the present invention. As shown, the originator computer 11 has originator software stored thereon that preferably includes software modules such as an originator graphical user interface (GUI) 21, a referral form generator 22, a secure originator connector 23, and a database of patient data 24. The referral form generator 22 generates different recipient-specific forms in which patient information can be entered. The database of patient data 24 is used to store patient forms. The originator GUI 21 provides a visually pleasing graphical user interface on a monitor 18 to facilitate the input and output of data by a user who is using the originator software within the originator computer 11. The secure originator connector 23 establishes a private communication session between the originator computer 11 and the server computer 13.

The recipient computer 12 has recipient software stored thereon that preferably includes software modules such as a recipient GUI 25, a referral checker 26, a secure recipient connector 27, and a database of referred patient data 28. The referral checker 26 accesses the server computer 13 at regular intervals to determine whether or not a new referral is available. The database of patient data 28 is utilized to store referrals transmitted to the recipient computer 12. The recipient GUI provides a visually pleasing graphical user interface on a monitor 18 to facilitate the input and output of data by a user who is using the recipient software within the recipient computer 12. The secure recipient connector 27 establishes a private communication session between the recipient computer 12 and the server computer 13.

The server computer 13 preferably includes software modules such as a secure server connector 31, an originator confirmer 32, a referral data mover 33, a recipient confirmer 34, and a referral transmission confirmer 35. The secure server connector 31 allows the originator computer 11 and the recipient computer 12 to communicate with the server computer 13 while keeping the nature of the communications private. The originator confirmer 32 confirms the identity of the originator computer 11. The referral data mover 33 receives referrals from the originator computer 11, and then transmits referrals to the recipient computer 12. The recipient confirmer 34 confirms the identity of the recipient computer 12. The referral transmission confirmer 35 records data related to a referral and transmits that data to the originator computer 11. The server computer 13 also has access to several databases, such as a database of originators 36, a database of referrals 37, a database of recipients 38, and a database of confirmations 39. The databases 36-39 are preferably located within the server computer 13 but may also be in communication with the server computer 13 via a LAN or via a global communications network such as the Internet. Also, the server computer 13 can be one of a plurality of computers each with a separate or portions of a database stored thereon.

III. Registration Process

The first time a healthcare originator executes the originator software in the originator computer 11, the healthcare originator has to register with the originator software as an originator. An example of a healthcare originator registration form GUI is shown in FIG. 3. The registration form GUI allows the healthcare originator to select an Authorization ID (or a login name) along with a password as a means for access control. The healthcare originator also has to enter an Approval code in order to use the originator software. The Approval code, which is preferably an alphanumeric code, can be obtained from an authorized recipient to whom the healthcare originator intended to send referrals. A similar registration process is also available in the recipient software in the recipient computer 12 for a recipient.

IV. Referral Process

After a healthcare originator, such as a doctor, has determined that a patient requires a specific type of healthcare that the healthcare originator does not or cannot provide, the healthcare originator then accesses the originator software within the originator computer 11 to make a referral to an appropriate recipient. For example, the originator can access the originator software by clicking on an icon displayed on the monitor of the originator computer 12 to initiate a communication link from the originator computer 11 to the recipient computer 12 as understood by those skilled in the art. The secure originator connector 23 within the originator computer 11 then transmits an encrypted connection request to the server computer 13. The encrypted connection request preferably includes a unique alphanumeric identification code (such as the above-mentioned Approval code) that can be used to compare with a list of originator identification codes stored in the database of originators 36 within the server computer 13. If the identification code transmitted by the secure originator connector 23 of the originator computer 11 matches with one of the originator identification codes stored in the database of originators 36, the secure server connector 31 of the server computer 13 then establishes a secure connection with the secure originator connector 23 of the originator computer 11.

Next, the referral form generator 22 of the originator computer 11 generates a referral form (or a recipient form). The referral form preferably includes various fill-in fields such as a Recipient field, a Patient Information field, a Contact Information field, a Physician Information field, a Medical Information field, and an Insurance Information field as they are known in the healthcare industry. The general layout and the specific fill-in fields in the referral form can be customized to each recipient, depending on the data required by the recipient. After the referral form has been generated, the referral form generator 22 then accesses the originator data stored within the originator computer 11. Each entry of stored originator data preferably includes a tag that corresponds to a tag associated with each fill-in field in the referral form that the originator has to enter. The referral form generator 22 then compares the tags from the referral form with the tags from the entry of the stored originator data. The referral form generator 22 then populates the entries of the referral form with the stored originator data according to the matching tags. The originator then enters the patient information and any other information, such as product information, that is required by the recipient into the referral form. The referral form is then transmitted to the server computer 13, along with a unique recipient identification code for identifying a specific recipient.

After receiving the referral form and the unique recipient identification code, the referral transmission confirmer 35 of the server computer 13 then compares the unique recipient identification code with all the recipient identification codes stored in the database of recipients 38. If the unique recipient identification code does not match with any of the codes in the database of recipients 38, then the server computer 13 transmits a message to the originator computer 11 stating that no recipient has been identified. Otherwise, if the unique recipient identification code matches with one of the recipient identification codes stored in the database of recipients 38, the recipient confirmer 34 transmits a confirmation message to the originator computer 11 signifying a recipient has been identified. The originator computer 11 then sends a request to the server computer 13 to confirm that the recipient has established an account on the server computer 13. If the confirmation is successful, the individual units of patient information and any product information associated with the patient information are then assigned a series of codes that correspond to the fields of the referral form, and the information is then stored in the database of patient data 24 of the originator computer 11. Alternatively, the storing of patient and product information can occur prior to the transmission of the referral form to the server computer 13. If the originator makes another referral that involves the same patient or the same product in the future, the referral form generator 22 accesses the database of patient data 24 and populates the referral form with patient and/or product information accordingly.

After the confirmation of recipient identity has been transmitted to the originator computer 11, the server computer 13 stores the patient referral information in the database of referrals 37 that is only accessible by a designated recipient via the recipient computer 12.

In order to retrieve the referral information, the recipient accesses the recipient software in the recipient computer 12, preferably by clicking on an icon displayed on the monitor of the recipient computer 12 as understood by those skilled in the art. The secure connector 27 of the recipient computer 12 then transmits an encrypted connection request to the server computer 13. The encrypted connection request also includes a unique alphanumeric recipient identification code that can be used to compare with a list of recipient identification codes previously stored in the database of recipients 38. A secure connection can be established if the unique recipient identification code transmitted by the recipient matches with one of the recipient identification codes stored in the database of recipients 38. Any referral contained in the database of referrals 37 for the above-mentioned matched recipient is then transmitted to the recipient computer 12. After the referral has been transmitted, the secure recipient connector 27 of the recipient computer 12 then transmits a confirmation of receipt of the referral back to the recipient confirmer 34 of the server computer 13. After receiving the confirmation from the recipient computer 12, the recipient confirmer 34 of the server computer 13 identifies the time of transmission and the patient information, and then stores all the referral information in the database of confirmations 39. If the originator computer 11 still has a secure connection with the server computer 13 at the time the recipient confirmer 34 generates the above-mentioned confirmation, the server computer 13 then immediately sends the confirmation to the originator computer 11 to provide an independent confirmation of the referral event.

As long as the recipient computer 12 maintains a secure connection to the server computer 13, the referral checker 26 within the recipient computer 12 can transmit a request for new referral data to the server computer 13 at regular intervals, such as every few minutes or every few hours. In response to a query of new referrals from the referral checker 26, the server computer 13 transmits any new referral to the recipient computer 12 if there is any new referral posted in the server computer 13. For each new referral received, the recipient computer 12 transmits a confirmation back to the referral confirmer 34 within the server computer 13.

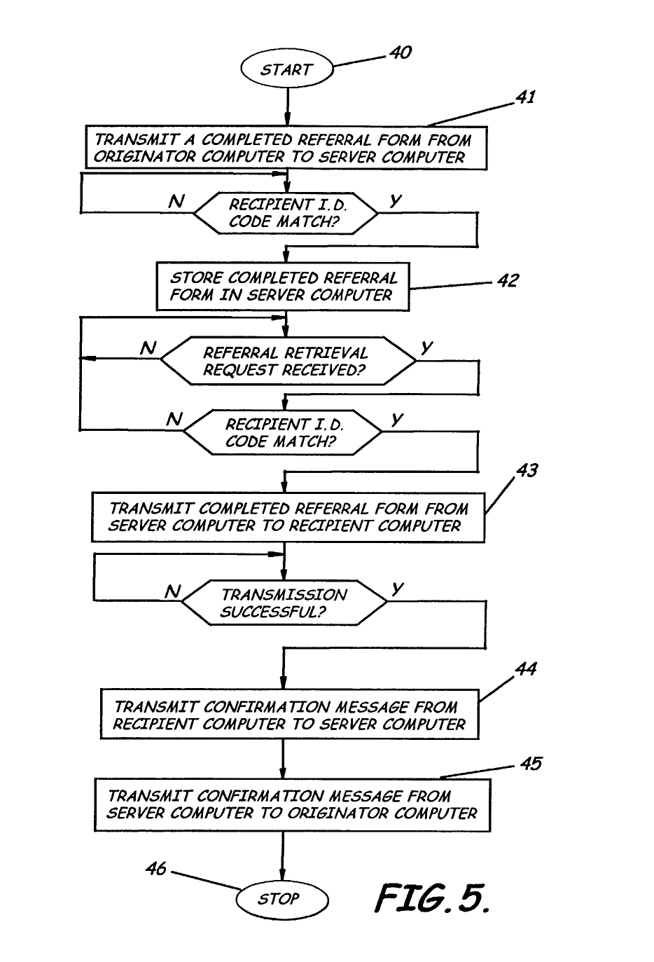

FIG. 5 is a logic flow diagram illustrating a method for processing healthcare referrals within the healthcare referral system 10, in accordance with an embodiment of the present invention. Starting at block 40, a completed referral form having a unique recipient identification code is transmitted from an originator computer to a server computer, as shown in block 41. If the unique recipient identification code of the completed referral form matches with one of the recipient identification codes stored in the server computer, the completed referral form is stored in the server computer, as depicted in block 42. In response to the receipt of a referral retrieval request initiated from a recipient computer by the server computer, and if the referral retrieval request includes a recipient identification code that matches with one of the unique recipient identification code stored in the server computer, the completed referral form is transmitted from the server computer to the recipient computer, as shown in block 43. After a successful transmission of the completed referral form from the server computer to the recipient computer, a confirmation message is transmitted from the recipient computer to the server computer, as depicted in block 44. In turn, a similar confirmation message is immediately transmitted from the server computer to the originator computer, as shown in block 45, to indicate the successful transmission of the referral.

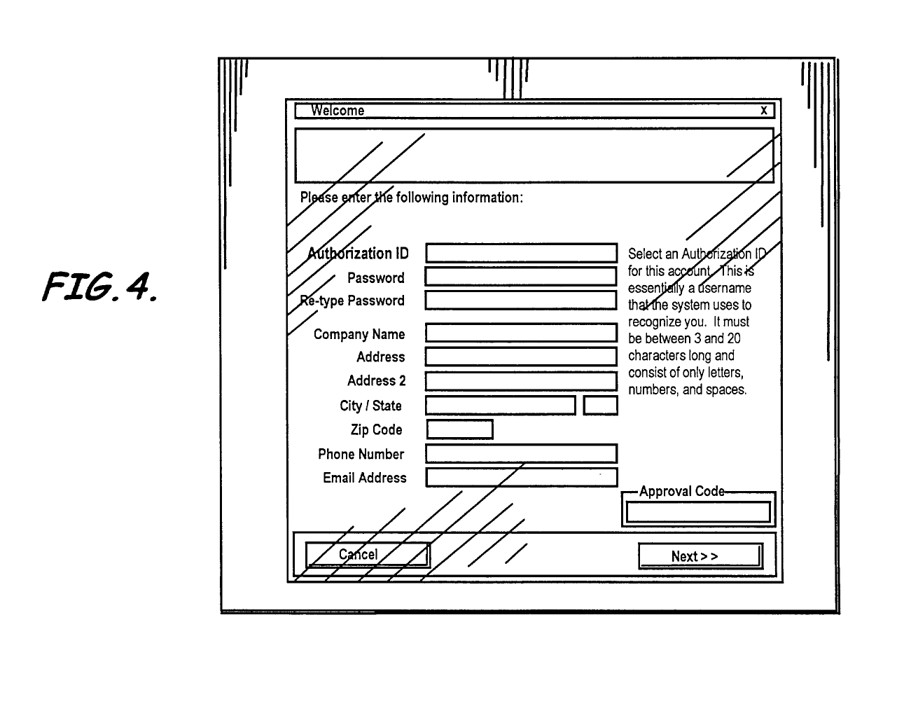

As has been described and illustrated in FIGS. 1-5, the present invention provides methods and a system 10 for processing healthcare referrals within the healthcare industry. With the present invention, a healthcare originator does not have to look up a recipient's telephone number, does not have to wade through an automated telephone attendance, and does not have to wait on an intake coordinator when making a referral. The referral information is stored in the originator computer and such information can be recalled automatically when the healthcare originator is making subsequent referrals for the same patient. Because the healthcare originator will receive a confirmation after the referral has been filled, the healthcare originator is assured that the referral has been taken care of. Although the system 10 as described herein is most applicable and advantageous as a healthcare referral system, it is also applicable to other applications such as a system for placing orders from a buyer to a seller in the context of related constraints.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

For example, the present invention also provides a computer program product residing on a computer usable medium for processing referrals such as in within a healthcare industry. The computer program product includes program code means for transmitting, e.g., a transmitter such as having elements described herein above, a completed referral form having a unique recipient identification code associated therewith from an originator computer to a server computer having the unique recipient identification code as one of a plurality of recipient identification codes stored therein, program code means for transmitting, e.g., a transmitter such as having elements described herein above, the completed referral form from the server computer to a recipient computer responsive to the receipt of a referral retrieval request from the recipient computer by the server computer and the referral retrieval request including a recipient identification code that matches the unique recipient identification code stored in the server computer, program code means for transmitting, e.g., a transmitter such as having elements described herein above, a second confirmation message from the recipient computer to the server computer responsive to a successful transmission of the completed referral form from the server computer to the recipient computer, and program code means for transmitting, e.g., a transmitter such as having elements described herein above, the second confirmation message from the server computer to the originator computer. Each of these means are preferably provided by software code or portions of code as understood by those skilled in the art and as describe and illustrated herein and preferably as interfacing between computers, servers, and hardware components as described herein.

Also, the product can also include program code means for establishing, e.g., an establisher such as having elements described and illustrated herein above, a secure connection between the originator computer and the server computer and program code means for establishing a secure connection between the recipient computer and the server computer. The recipient identification code can be an alphanumeric code or other preselected code as desired. The referral retrieval request can advantageously be sent from the recipient computer at regular intervals. The product can further include program code means for transmitting, e.g., a transmitter such as having elements described herein above, an initial confirmation message from the server computer to the originator computer responsive to the unique recipient identification code in the completed referral form matching one of the plurality of recipient identification codes stored in the server computer. The program code means for transmitting the confirmation message further includes program code means for immediately transmitting, e.g., a transmitter such as having software elements described herein above, the confirmation message from the server computer to the originator computer.

As illustrated in FIGS. 1-5, and as described above, the present invention also includes a method for processing healthcare referrals within healthcare industry. The method includes transmitting a completed referral form having a unique recipient identification code associated therewith from an originator computer to a server computer having the unique recipient identification code as one of a plurality of recipient identification codes stored therein, transmitting the completed referral form from the server computer to a recipient computer responsive to the receipt of a referral retrieval request from the recipient computer by the server computer and the referral retrieval request including a recipient identification code that matches with the unique recipient identification code stored in the server computer, transmitting a confirmation message from the recipient computer to the server computer responsive to a successful transmission of the completed referral form from the server computer to the recipient computer, and transmitting the confirmation message from the server computer to the originator computer. The method can also include establishing a secure connection between the originator computer and the server computer prior to the step of transmitting the completed referral form between the originator computer and the server computer and establishing a secure connection between the recipient computer and the server computer prior to the step of transmitting the completed referral form between the recipient computer and the server computer. The recipient identification code, for example, can be an alphanumeric code or other preselected code as desired. The referral retrieval request can advantageously be sent from the recipient computer at pre-selected regular intervals. The method can further include transmitting an initial confirmation message from the server computer to the originator computer responsive to the unique recipient identification code in the completed referral form matching with one of the plurality of recipient identification codes stored in the server computer. The transmitting the confirmation message step can further include immediately transmitting the confirmation message from the server computer to the originator computer.

The system as illustrated and described can advantageously include a server computer, an originator computer having originator software stored therein, a recipient computer having recipient software stored therein, a database of originators, a database of recipients, a database of referrals, and a database of confirmations. The healthcare referral system advantageously shortens the time to make a referral and reduces referral data error by populating forms with originator and patient data required by the recipient and transmitting the referral to the recipient via the server computer. The healthcare referral system also provides detailed records of the referral by storing referred patient data on the recipient's computer and transmitting a confirmation of referral and referral time to the originator.

Although the invention has been particularly shown and described with reference to illustrated embodiments, it will be understood by those skilled in the art that various changes in form and detail may be made therein without departing from the spirit and scope of the invention.

That claimed is:

1. A method for processing healthcare referrals within healthcare industry, the method comprising:
transmitting a completed referral form having a unique recipient identification code associated therewith from an originator computer to a server computer having the unique recipient identification code as one of a plurality of recipient identification codes stored therein;
transmitting the completed referral form from the server computer to a recipient computer responsive to the receipt of a referral retrieval request from the recipient computer by the server computer and the referral retrieval request including a recipient identification code that matches with the unique recipient identification code stored in the server computer;
transmitting a confirmation message from the recipient computer to the server computer responsive to a successful transmission of the completed referral form from the server computer to the recipient computer; and
transmitting the confirmation message from the server computer to the originator computer.

2. A method as defined in claim 1, further comprising establishing a secure connection between the originator computer and the server computer prior to the step of transmitting the completed referral form between the originator computer and the server computer.

3. A method as defined in claim 1, further comprising establishing a secure connection between the recipient computer and the server computer prior to the step of transmitting the completed referral form between the recipient computer and the server computer.

4. A method as defined in claim 1, wherein the recipient identification code comprises an alphanumeric code.

5. A method as defined in claim 1, wherein the referral retrieval request is sent from the recipient computer at pre-selected regular intervals.

6. A method as defined in claim 1, further comprising transmitting an initial confirmation message from the server computer to the originator computer responsive to the unique recipient identification code in the completed referral form matching with one of the plurality of recipient identification codes stored in the server computer.

7. A method as defined in claim 1, wherein the transmitting the confirmation message step further includes immediately transmitting the confirmation message from the server computer to the originator computer.

8. A method for processing referrals, the method comprising:
transmitting a completed referral form having a unique recipient identification code associated therewith from an originator computer to a server computer having the unique recipient identification code as one of a plurality of recipient identification codes stored therein;
transmitting the completed referral form from the server computer to a recipient computer responsive to the receipt of a referral retrieval request from the recipient computer by the server computer and the referral retrieval request including a recipient identification code corresponding to the unique recipient identification code stored in the server computer; and
transmitting a confirmation message from the recipient computer to the server computer responsive to a successful transmission of the completed referral form from the server computer to the recipient computer.

9. A computer program product residing on a computer usable medium for processing healthcare referrals within a healthcare industry, the computer program product comprising:
program code means for transmitting a completed referral form having a unique recipient identification code associated therewith from an originator computer to a server computer having the unique recipient identification code as one of a plurality of recipient identification codes stored therein;
program code means for transmitting the completed referral form from the server computer to a recipient computer responsive to the receipt of a referral retrieval request from the recipient computer by the server computer and the referral retrieval request including a recipient identification code that matches the unique recipient identification code stored in the server computer;
program code means for transmitting a second confirmation message from the recipient computer to the server computer responsive to a successful transmission of the completed referral form from the server computer to the recipient computer; and
program code means for transmitting the second confirmation message from the server computer to the originator computer.

10. A computer program product as defined in claim 9, further comprising program code means for establishing a secure connection between the originator computer and the server computer.

11. A computer program product as defined in claim 10, further comprising program code means for establishing a secure connection between the recipient computer and the server computer.

12. A computer program product as defined in claim 11, wherein the recipient identification code comprises an alphanumeric code.

13. A computer program product as defined claim 12, wherein the referral retrieval request is sent from the recipient computer at regular intervals.

14. A computer program product as defined claim 13, further comprising program code means for transmitting an initial confirmation message from the server computer to the originator computer responsive to the unique recipient identification code in the completed referral form matching one of the plurality of recipient identification codes stored in the server computer.

15. A computer program product as defined in claim 14, wherein the program code means for transmitting the confirmation message further includes program code means for immediately transmitting the confirmation message from the server computer to the originator computer.

16. A computer program product residing on a computer usable medium for processing referrals, the computer program product comprising:
program code means for transmitting a completed referral form having a unique recipient identification code associated therewith as one of a plurality of recipient identification codes stored therein;
program code means for transmitting the completed referral form responsive to the receipt of a referral retrieval request, the referral retrieval request including a recipient identification code corresponding to the unique recipient identification code; and
program code means for transmitting a second confirmation message responsive to a successful transmission of the completed referral.

17. A computer system for processing healthcare referrals within healthcare industry, the computer system comprising:
means for transmitting a completed referral form having a unique recipient identification code associated therewith from an originator computer to a server computer having the unique recipient identification code as one of a plurality of recipient identification codes stored therein;
means for transmitting the completed referral form from the server computer to a recipient computer responsive to the receipt of a referral retrieval request from the recipient computer by the server computer and the referral retrieval request including a recipient identification code that matches one of the plurality of recipient identification codes stored in the server computer;
means for transmitting a second confirmation message from the recipient computer to the server computer after a successful transmission of the completed referral form from the server computer to the recipient computer; and
means for transmitting the second confirmation message from the server computer to the originator computer.

18. A computer system as defined in claim 17, further comprising means for establishing a secure connection between the originator computer and the server computer prior to the transmission between the originator computer and the server computer.

19. A computer system as defined in claim 17, further comprising means for establishing a secure connection between the recipient computer and the server computer prior to the transmission between the recipient computer and the server computer.

20. A computer system as defined in claim 17, wherein the recipient identification code comprises an alphanumeric code.

21. A computer system as defined in claim 17, wherein the referral retrieval request is sent from the recipient computer at pre-selected regular intervals.

22. A computer system as defined in claim 17, further comprising means for transmitting an initial confirmation message from the server computer to the originator computer responsive to the recipient identification code in the completed referral form matching the unique recipient identification code stored in the server computer.

23. A computer system as defined in claim 17, wherein the means for transmitting the confirmation message further includes means for immediately transmitting the confirmation message from the server computer to the originator computer.

24. A computer system for processing referrals, the computer system comprising:
a transmitter positioned to transmit a completed referral form having a unique recipient identification code associated therewith from an originator computer to a server computer having the unique recipient identification code as one of a plurality of recipient identification codes stored therein;
a transmitter positioned to transmit the completed referral form from the server computer to a recipient computer responsive to the receipt of a referral retrieval request from the recipient computer by the server computer and the referral retrieval request including a recipient identification code that matches one of the plurality of recipient identification codes stored in the server computer; and
a transmitter positioned to transmit a second confirmation message from the recipient computer to the server computer after a successful transmission of the completed referral form from the server computer to the recipient computer.

25. A computer system as defined in claim 24, further comprising a transmitter positioned to transmit the second confirmation message from the server computer to the originator computer and an establisher positioned to establish a secure connection between the originator computer and the server computer prior to the transmission between the originator computer and the server computer.

26. A computer system as defined in claim 25, further comprising an establisher positioned to establish a secure connection between the recipient computer and the server computer prior to the transmission between the recipient computer and the server computer.

27. A computer system as defined in claim 24, wherein the recipient identification code comprises an alphanumeric code.

28. A computer system as defined in claim 24, wherein the referral retrieval request is sent from the recipient computer at pre-selected regular intervals.

29. A computer system as defined in claim 24, further comprising a transmitter positioned to transmit an initial confirmation message from the server computer to the originator computer responsive to the recipient identification code in the completed referral form matching the unique recipient identification code stored in the server computer.

30. A computer system as defined in claim 24, wherein the transmitter positioned to transmit the confirmation message further includes means for immediately transmitting the confirmation message from the server computer to the originator computer.
